(19) United States
(12) Patent Application Publication
(10) Pub. No.: US 2008/0029542 A1
(43) Pub. Date: Feb. 7, 2008

(54) Dispensing Assembly for Two Components , Including a Syringe or Dispensing Cartidge and a Mixer

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: MIXPAC SYSTEMS AG

(21) Appl. No.: 11/628,718

(22) PCT Filed: Jul. 1, 2005
(86) PCT No.: PCT/CH05/00369

§ 371 Date: Dec. 7, 2006

(30) Foreign Application Priority Data
Jul. 8, 2004 (CH) 1168/04

(51) Int. Cl. B05C 17/005; B67D 5/52

(52) U.S. Cl. 222/145.5; 222/137

(57) ABSTRACT

The invention relates to a system for dispensing two components, including a syringe or cartridge and a mixer. The system is characterized in that the edges of the mixer inlet openings on the cartridge end and the transfer channel outlets linked with the cartridge outlets are disposed and configured to allow a vacuum-free replacement of the mixer. The planes of the openings on the adapter outlets or on the cartridge outlets or the planes of the openings of the mixer inlets form an angle, especially an angle of 90°, with the longitudinal axes of the outlets or inlets. The inventive systems allows removal of the mixers without producing a vacuum, thereby preserving the filling level of the two components and allowing a correct mixing ratio from the outset once the new mixer is placed on the syringe or cartridge.

### CROSS-REFERENCE TO RELATED APPLICATIONS

This application is the National Phase of PCT/CH2005/000369, filed Jul. 1, 2005, and published as WO 2006/005205, which claims priority from Switzerland Application No. 1168/04, filed Jul. 8, 2004, the contents of these applications are incorporated herein by reference.

### FIELD OF THE INVENTION

The present invention relates to a dispensing assembly for two components including a syringe or dispensing cartridge and a mixer, such assemblies being intended in particular for surgical applications.

A large number of assemblies for dispensing two component materials are on the market in which adhesives or other materials are dispensed from double syringes, double cartridges, or similar dispensing appliances and mixed by means of a static mixer. Frequently, the materials are not dispensed until the cartridges are empty but only partly so that the components in the mixer will harden.

Thus, to continue working, a mixer replacement is required while it has to be prevented that the cartridge outlets are blocked by hardening material. Another problem in the removal of mixers designed according to the prior art is the creation of a vacuum. As soon as the mixer is separated from the cartridge, the liquid column between the mixer inlet and the cartridge outlet is disrupted and the vacuum is relieved. However, the separation between the components in the cartridge outlet and those in the mixer inlet is not precisely defined and differences in viscosity may have a significant influence. In this situation, when a new mixer is attached, the two components are not at the same filling level during the dispensing operation and will therefore not be mixed at the correct ratio in the initial phase. Therefore, to avoid a defective adhesive bond, the initial mixture must not be used.

In the future, in surgical applications, fast-reacting two-component substances will be dispensed during an operation in small quantities and in several steps. This means that one static mixer is needed in each dispensing operation as the two components in the mixer harden quite quickly. Since the dispensed volumes are small and in addition the media harden quickly after mixing, the resulting requirement is a correct ratio from the beginning as it is problematic to perform a leveling operation after each mixer replacement, i.e. to dispense the mixture until the ratio is correct.

U.S. Pat. No. 6,530,685 discloses a dispensing device including a dispensing appliance and a mixer where the aim is to minimize the compressive forces acting between the outlets of the dispensing appliance and the inlets of the mixer. The solution is that the outlets on the outlet flange of the dispensing appliance are directed radially inwards and the openings in the mixer housing are also radially arranged.

German Publication No. 32 37 353 discloses a mixing arrangement where the outlets of the two containers are radially arranged and the inlets and outlets are sealed by a rotatable sleeve.

U.S. Pat. No. 4,690,306 discloses an exemplary embodiment in which the outlets connect to the inlets of the mixing device radially.

### SUMMARY OF THE INVENTION

None of the prior art references addresses the leveling problem during mixer replacement, and therefore, on the background of this prior art, it is the object of the present invention to provide an assembly for dispensing two components that allows replacing the mixer without affecting the equal filling level of the two components. This is accomplished by the assembly according to claim 1.

### A BRIEF DESCRIPTION OF THE DRAWINGS

The invention will be explained in more detail hereinafter with reference to drawings of exemplary embodiments.

FIG. 1 shows schematically and in a sectional view an assembly of the invention with an attached mixer having inwardly directed transfer channels,

FIG. 2 shows the assembly of FIG. 1 with a closing cap,

FIG. 3 shows a variant of the embodiment of FIG. 1,

FIG. 4 shows schematically and in a sectional view a second assembly of the invention with an attached mixer having outwardly directed transfer channels,

FIG. 5 shows schematically and in a sectional view a third assembly of the invention with an attached mixer and outwardly directed transfer channels,

FIG. 6 shows schematically and in a sectional view a fourth assembly of the invention with an attached mixer and outwardly directed transfer channels,

FIG. 6A shows a cross-section according to line VIA-VIA in FIG. 6,

FIG. 7 shows the assembly of FIG. 6 in a rotated position, and

FIG. 7A shows a cross-section according to line VIIA-VIIA in FIG. 7.

### DETAILED DESCRIPTION OF THE INVENTION

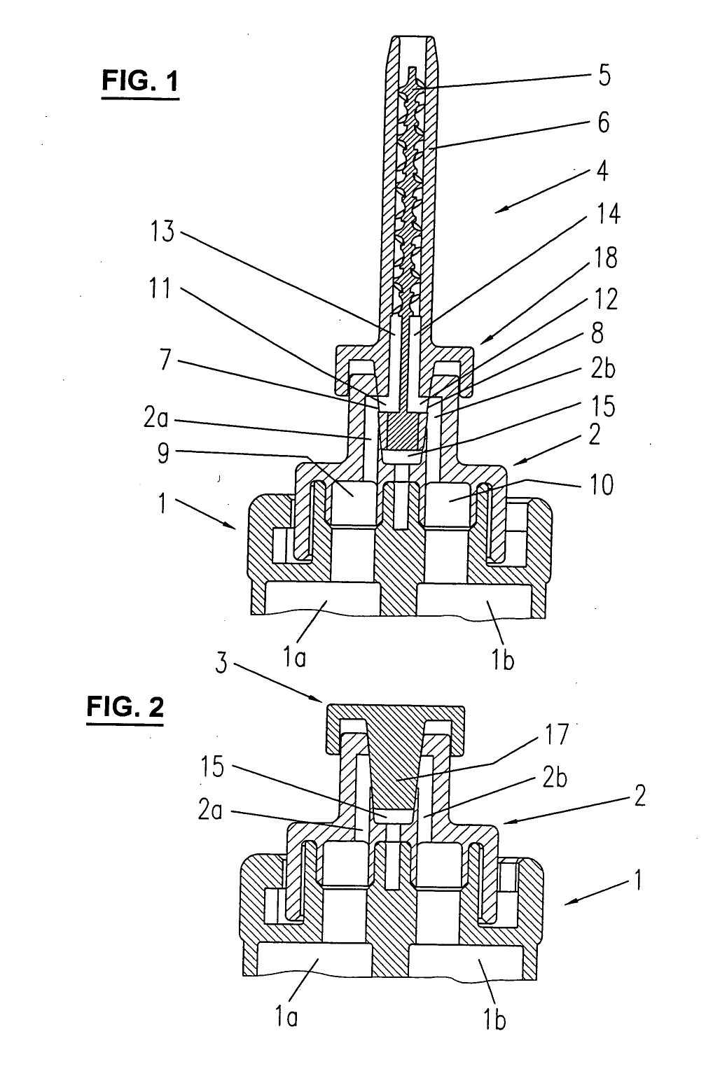

FIG. 1 illustrates the outlet side of cartridge 1 with the two containers 1a and 1b, an adapter 2 and a mixer 4, and FIG. 2 a closing cap 3. The two outlets 9 and 10 of the cartridge lead into inwardly directed transfer channels 2a and 2b of the adapter and outlets 7 and 8 of the transfer channels into mixer inlets 11 and 12. In contrast to conventional mixers, mixer inlets 11 and 12 are followed by two separating chambers 13 and 14 in order to definitely exclude any cross contamination at the cartridge/mixer interface and thus any hardening during mixer replacement. At the end of the separating chambers, mixing element 5 is arranged which is enclosed in mixer housing 6.

It is not inventively essential here how the adapter is fastened to the cartridge. In the present case, it is a snap-on arrangement. If conventional cartridges with bayonet sockets are used, it is also possible to provide corresponding bayonet members on the adapter for fastening it to the mixer. However, other fastening methods are also possible.

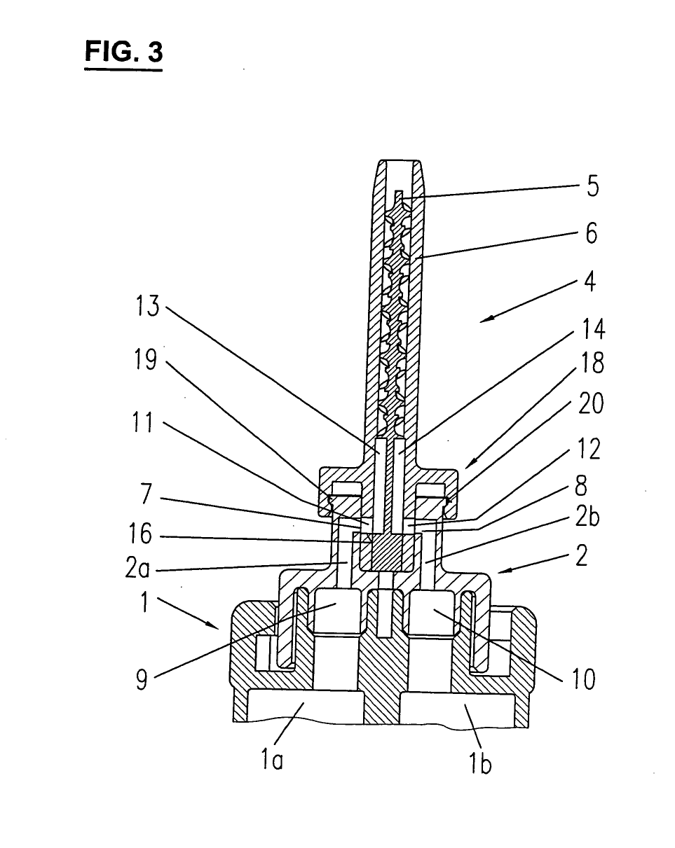

As illustrated in FIG. 1, the mixer inlets are not arranged frontally as in usual mixers but two lateral openings 11 and 12 are provided, the mixer inlet section between the mixer inlets and the end of the mixer inlets being conically shaped while the mixer inlet section in FIG. 3 is cylindrical.

Cavity 15 of adapter 2 that receives the mixer inlet section is also conically shaped while cavity 16 of adapter 26 in FIG. 3 is cylindrically shaped.

In FIG. 2, closing cap 3 is placed on the adapter, transfer channels 2a and 2b being effectively sealed by plug 17 at closing cap 3.

The variant of FIG. 1 shown in FIG. 3 has already been discussed, the difference being the fact that the mixer inlet section is designed cylindrically rather than conically. Another difference between the embodiment according to FIG. 1 and that according to FIG. 3 is that inlet portion 18 of the mixer housing, which is pushed over the adapter, has a groove 20 at its end in which the bead 19 on the front side of the adapter engages.

To dispense and mix the two components, closing cap 3 is removed and mixer 4 is attached. The mixer is attached in a radially oriented manner, the orientation being provided by notches and noses or by a corresponding geometrical shape of the adapter and the mixer housing.

During mixer replacement, the medium is divided between transfer channels 2a and 2b and mixer inlets 11 and 12 in a vacuum-free manner. This division occurs in that the liquid stream is sheared off by the edges of the transfer channel outlets and of the mixer inlets. This is due to the fact that the outlets of the cartridge and of the transfer channels, respectively, and the mixer inlets are not in line with the longitudinal axis of the mixer but are arranged orthogonally thereto, whereby the outlet and inlet openings are gradually reduced as the mixer is withdrawn such that no vacuum may form. In this manner, the synchronization of the two components is preserved and it is no longer necessary to level out the components when a new mixer is attached, i.e. it is possible to continue working immediately without previously dispensing material until the correct mixing ratio is achieved.

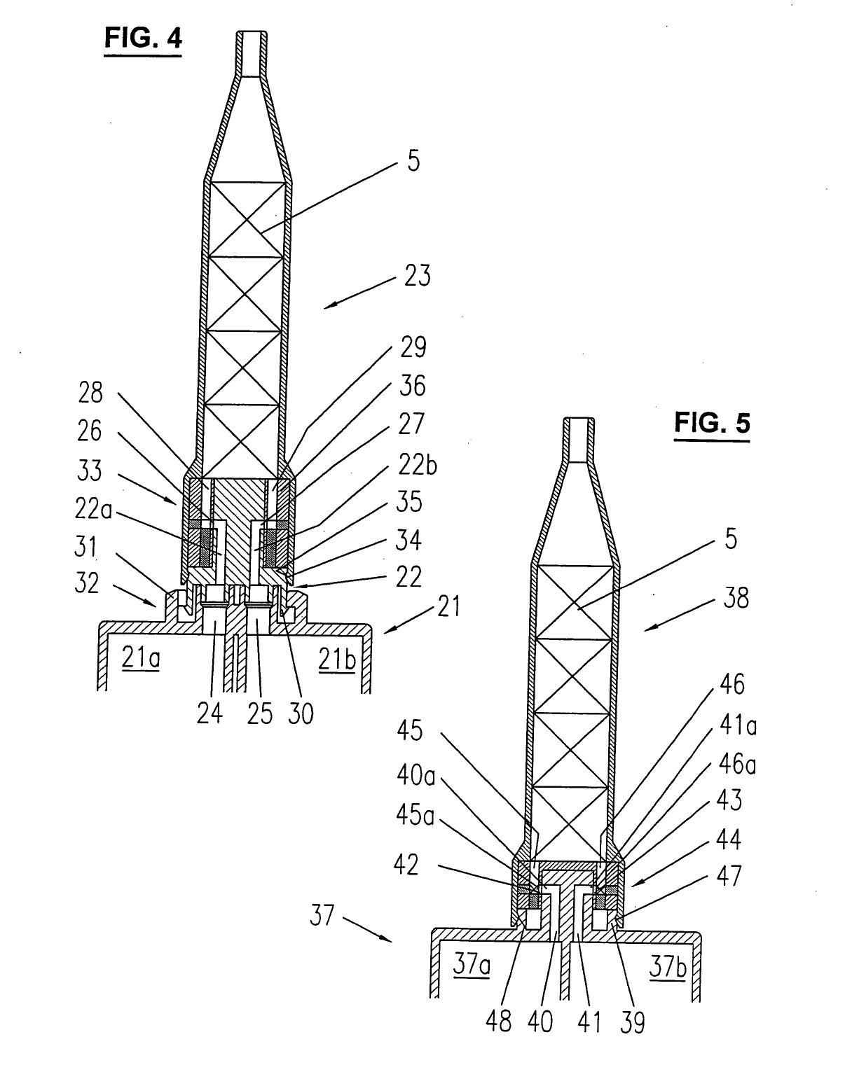

In the two exemplary embodiments according to FIGS. 4 and 5, the transfer channel outlets extend outwardly. FIG. 4 shows the outlet side of a cartridge 21 with the two separate storage containers 21a and 21b, an adapter 22, and a mixer 23. The two outlets 24 and 25 of the cartridge lead into transfer channels 22a and 22b of the adapter and the outwardly directed, transversally extending outlets 26, 27 of the transfer channels into mixer inlets 28 and 29. The mixer inlets are located in a cylindrical portion 36 arranged in the mixer inlet section.

At its cartridge side end, adapter 22 has a circumferential collar 30 that engages under bayonet sockets 31 on outlet section 32 in order to secure the adapter. The cartridge side end of mixer inlet section 33 is provided with a circumferential inner bead 34 that snaps into a groove 35 of the adapter.

The relatively long inlets 22a, 22b and 40, 41 have the same effect as separating chambers 13, 14, i.e. to separate the components as long as possible. The shearing effect in this exemplary embodiment is the same as in the previous examples since here also the mixer inlet openings and the openings of the transfer channel outlets are arranged orthogonally to the longitudinal axis of the mixer and the edges of outlets 26, 27 of transfer channels 22a, 22b slide past the edges of mixer inlets 28, 29.

In the exemplary embodiment according to FIG. 5, there is no adapter between cartridge 37 and mixer 38. Cartridge 37 has two storage containers 37a, 37b which are not spaced apart and an outlet section 39 in which the two outlets 40 and 41 are arranged. The outlets lead into respective outwardly directed, transversally extending outlet channels 40a, 41a ending at respective outlet channel openings 42, 43.

Mixer inlet section 44 has two mixer inlet channels 45, 46 extending in parallel to the longitudinal axis and leading to respective lateral openings 45A, 46A, and at its cartridge side end a circumferential inner bead 47 that snaps into a groove 48 in the outlet section in order to secure the mixer. In this example, like in the previous example, the shearing action during mixer removal occurs at the transfer channel openings 42 and 43 and openings 45A and 46A of mixer inlet channels 45 and 46.

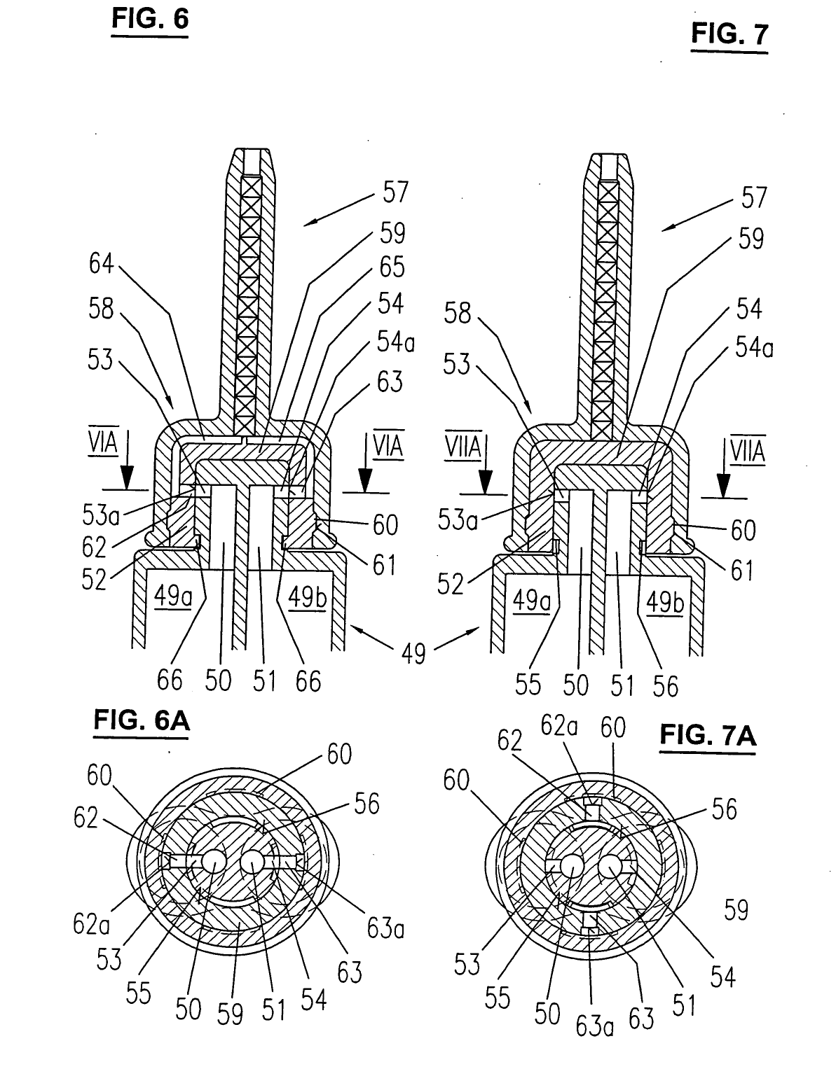

In the exemplary embodiment according to FIGS. 6-7 with outwardly directed transfer channels, the liquid is sheared off by rotating the mixer with respect to the cartridge. Cartridge 49 comprises two storage containers 49a and 49b having respective outlets 50 and 51 in outlet section 52. The outlets lead to an outwardly directed, transversally extending transfer channel 53, 54 with openings 53A, 54A. Outlet section 52 further comprises two bayonet sockets 55, 56.

Mixer 57 is provided in its inlet section 58 with an insert 59 that is fastened therein by cams 60 engaging in internal grooves 61 in the housing of the mixer inlet section. At the height of the transfer channel openings, insert 59 has two transversally extending bores 62 and 63 with inlet openings 62a, 63a. Starting from these bores, two recesses forming inlet channels 64, 65 with the mixer housing and leading to the mixing elements are arranged in the insert surface facing the mixer outlet. The cartridge side end of mixer inlet section 58 has two bayonet cams 66 which cooperate with bayonet sockets 55, 56 on the cartridge.

Particularly when comparing FIGS. 6A with 7A it is apparent that during mixer removal, the latter must perform a rotating movement in order to rotate the bayonet cams out of the bayonet sockets and that inlet openings 63a, 63a consequently slide past transfer channel openings 53a, 54a and the latter are sealed by the inner wall of the insert so that the mixer may be withdrawn without possibly creating a vacuum in the transfer channels.

As in the examples according to FIGS. 1 to 3, a closing cap is also provided in the exemplary embodiments according to FIGS. 4 to 7 which may be fastened as disclosed there.

As mentioned before, the manner of coupling between the mixer and the adapter, on one hand, and between the adapter and the cartridge, on the other hand, is not inventively essential and may be designed in numerous ways as by snap, catch, or cone connections. Furthermore, all embodiments may be provided with bayonet or bayonet-like couplings. It is essential, though, that the inlets and outlets are not in line, i.e. that the planes of the openings at the outlets of the adapter or of the cartridge and the planes of the openings at the inlets of the mixer form an angle, more particularly of 90°, with the longitudinal axes of the outlets and inlets, respectively, the inlets respectively outlets being generally arranged in parallel to the longitudinal axis of the mixer or cartridge. In this manner, when the mixer is withdrawn, a lateral mutual displacement of the channel cross-sections results whereby a vacuum-free removal of the mixer without affecting the filling level of the two components is possible.

It is also understood that the volumetric ratio of the components, respectively the cross-sectional ratio of the storage containers does not necessarily have to be equal to 1:1 but may be different from 1:1. Correspondingly, the outlets and the transfer channels may also have different, adapted cross-sections.

What is claimed is:

1. An assembly for dispensing at least two components, including a syringe or cartridge and a mixer, wherein the edges of the mixer inlet openings on the cartridge side thereof and the transfer channel outlets that are connected to the cartridge outlets are arranged and configured to allow a vacuum-free replacement of the mixer.

2. An assembly according to claim 1, wherein an adapter having transfer channels is arranged between the syringe or cartridge and the mixer.

3. An assembly according to claim 1, wherein the planes of the openings at the adapter outlets or at the cartridge outlets and the planes of the openings of the mixer inlets form an angle, more particularly of 90°, with the longitudinal axes of the outlets and inlets, respectively.

4. An assembly according to claim 2, wherein the adapter has an inlet for each syringe or cartridge outlet the inlet leading into a transfer channel whose outlets correspond to the mixer inlets.

5. An assembly according to claim 4, wherein the adapter has a cavity that is adapted to receive a mixer inlet section of the mixer.

6. An assembly according to claim 5, wherein the cavity in the adapter and/or the mixer inlet section are conically and/or cylindrically shaped.

7. An assembly according to claim 2, wherein the transfer channel outlets of the adapter and the mixer inlets corresponding thereto are positioned at the same height when the mixer is attached.

8. An assembly according to claim 1, wherein a closing cap having a central plug is provided for sealing the transfer channels of the adapter or of the cartridge.

9. An assembly according to claim 1, wherein the transfer channel outlets in the adapter extend inwardly.

10. An assembly according to claim 1, wherein the transfer channel outlets in the adapter extend outwardly.

11. An assembly according to claim 1, wherein the mixer is directly fastened to the cartridge or syringe, the cartridge outlets leading into respective outwardly extending transfer channels whose edges correspond to the edges of the inlet openings that are arranged transversally to the longitudinal axis of the mixer.

12. An assembly according to claim 11, wherein the mixer has a circumferential inner bead at its cartridge side end that snaps into a groove in such a manner that the mixer can be withdrawn.

13. Assembly according to claim 11, wherein the mixer as an insert with transversally extending inlet bores and inlet channels in its inlet section and bayonet cams at its cartridge side end, the inlet openings of the inlet bores sliding past the transfer channel outlets of the cartridge and sealing them in order to allow a vacuum-free withdrawal of the mixer when the bayonet coupling is disengaged.
